(19) United States
(12) Patent Application Publication
(10) Pub. No.: US 2015/0350653 A1
(43) Pub. Date: Dec. 3, 2015

(54) IMAGE COMPRESSION BASED ON DEVICE ORIENTATION AND LOCATION INFORMATION

(71) Applicant: Apple Inc., Cupertino, CA (US)

(72) Inventors: Jae Hoon Kim, San Jose, CA (US); Shujie Liu, Cupertino, CA (US); Dazhong Zhang, Milpitas, CA (US); Xiaosong Zhou, Campbell, CA (US); Chris Y. Chung, Sunnyvale, CA (US); Hsi-Jung Wu, San Jose, CA (US)

(73) Assignee: Apple Inc., Cupertino, CA (US)

(21) Appl. No.: 14/288,969

(22) Filed: May 28, 2014

(51) Int. Cl. H04N 19/137; H04N 19/142; H04N 19/51

(52) U.S. Cl. CPC H04N 19/137; H04N 19/51; H04N 19/142

(57) ABSTRACT

An encoding system may include a video source that provides video data to be coded, a video coder, a transmitter, and a controller to manage operation of the system. The controller may control the video coder to code and compress the image information from the video source into video data, based upon one or more motion prediction parameters. The transmitter may transmit the video data. A decoding system may decode the video data based upon the motion prediction parameters.

### BACKGROUND

In video recording, camera typically captures and encodes video frames in landscape regardless of the orientation of the camera device, even when the overall video data may be marked with orientation information to allow a display to reorient the video. Thus, captured frames tend to be coded in landscape. Video codecs, however, may need to be designed to maximize both spatial and temporal correlation of pixel data.

For example, generally in natural scenes, more horizontal motions tend to occur. Also considering that the scanning order of the frame pixels during the compression is a zig-zag pattern scanning from left to right and from top to bottom, having similar pixel blocks in the same zig-zag order can improve coding/compression efficiency.

Thus, there is a need to improve coding and decoding of video data.

### BRIEF DESCRIPTION OF THE DRAWINGS

FIG. 1 illustrates a communication system according to an embodiment of the present disclosure.

FIG. 2 illustrates a decoding system according to an embodiment of the present disclosure.

FIG. 3 illustrates a coding system according to an embodiment of the present disclosure.

FIG. 4 illustrates a decoding method according to an embodiment of the present disclosure.

FIG. 5 illustrates a coding method according to an embodiment of the present disclosure.

FIGS. 6A and 6B illustrate a coding method according to an embodiment of the present disclosure.

### DETAILED DESCRIPTION

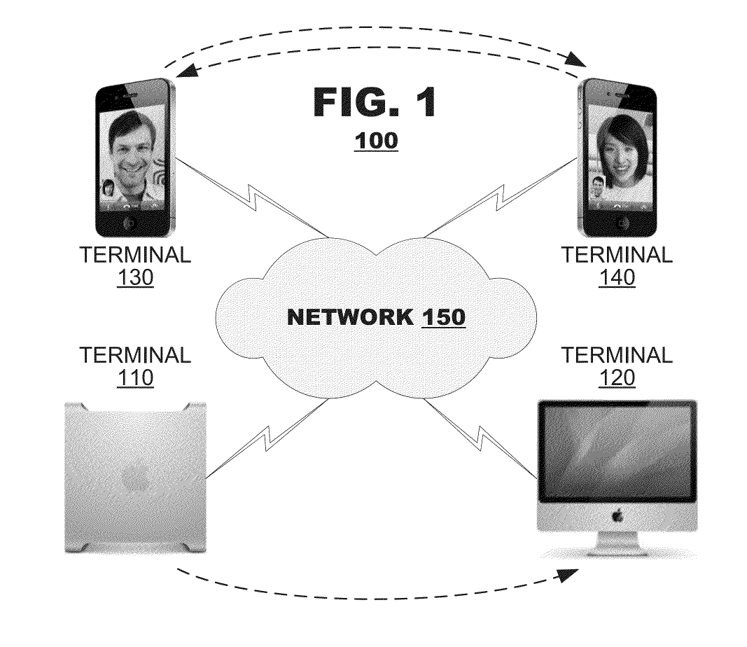

FIG. 1 illustrates a simplified block diagram of a communication system 100 according to an embodiment of the present invention. The system 100 may include at least two terminals 110-120 interconnected via a network 150. For unidirectional transmission of data, a first terminal 110 may code video data at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be illustrated as servers, personal computers and smart phones but the principles of the present invention may be not so limited. Embodiments of the present invention find application with laptop computers, tablet computers, media players and/or dedicated video conferencing equipment. The network 150 represents any number of networks that convey coded video data among the terminals 110-140, including for example wireline and/or wireless communication networks. The communication network 150 may exchange data in circuit-switched and/or packet-switched channels. Representative networks include telecommunications networks, local area networks, wide area networks and/or the Internet. For the purposes of the present discussion, the architecture and topology of the network 150 may be immaterial to the operation of the present invention unless explained hereinbelow.

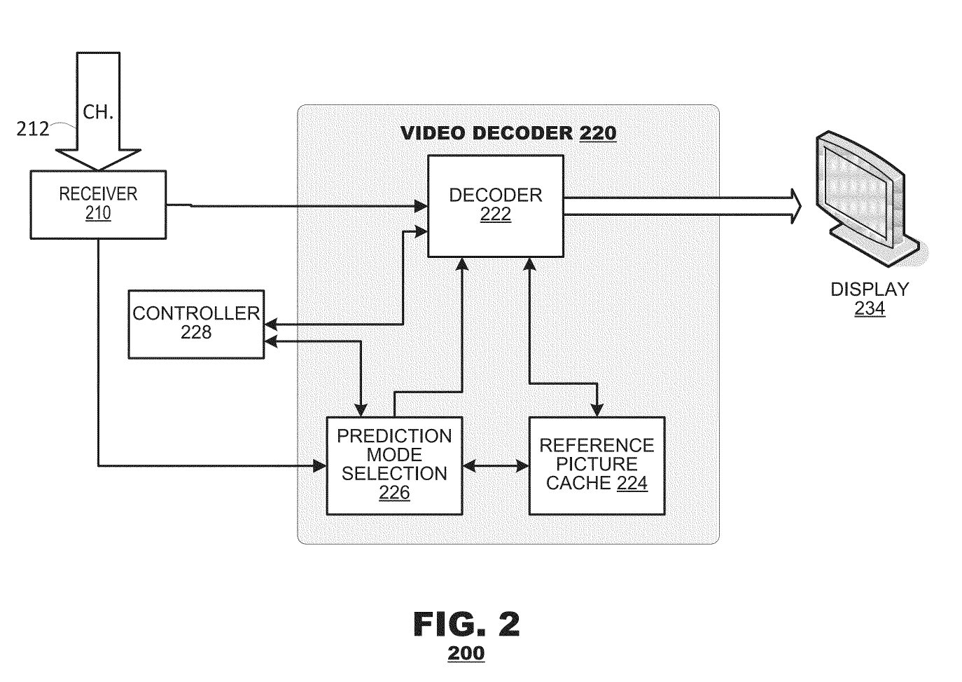

FIG. 2 may be a functional block diagram of a video decoding system 200 according to an embodiment of the present invention.

The video decoding system 200 may include a receiver 210 that receives encoded video data, a video decoder 220, a controller 228 to manage operation of the system 200 and a display 234 to display the decoded video data. The video decoder 220 may decode video sequence received. The controller 228 may control the video decoder 220 to adjust decoding of motion prediction, based upon one or more of parameters in the encoded video data.

The parameters in the encoded video may include data of camera orientation, camera motion, specific pixel block designations for motion prediction purposes, etc. Additional details of the parameters will be described below.

The receiver 210 may receive video to be decoded by the system 200. The encoded video data may be received from a channel 212, which may be a hardware/software link to a storage device which stores the encoded video data. The receiver 210 may receive the encoded video data with other data, for example, coded audio data and/or ancillary data streams. The receiver 210 may separate the encoded video data from the other data.

The video decoder 220 may perform decoding operation on the video sequence received from the receiver 210. The video decoder 220 may include a decoder 222, a reference picture cache 224, and a prediction mode selection 226 operating under control of controller 228. The decoder 222 may reconstruct coded video data received from the receiver 210 with reference to reference pictures stored in the reference picture cache 224. The decoder 222 may output reconstructed video data to display 234 for display. Reconstructed video data of reference frames also may be stored to the reference picture cache 224 for use during decoding of subsequently received coded video data.

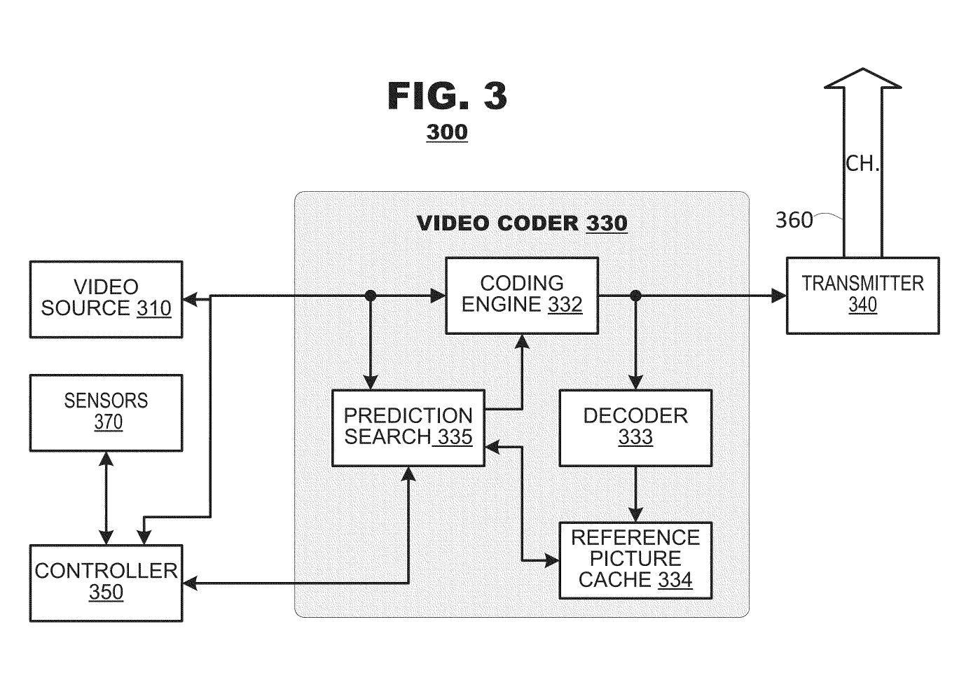

The decoder 222 may perform decoding operations that invert coding operations performed by the video coder 330 (shown in FIG. 3). The decoder 222 may perform entropy decoding, dequantization and transform decoding to generate recovered pixel block data. Quantization/dequantization operations may be lossy processes and, therefore, the recovered pixel block data likely will be a replica of the source pixel blocks that were coded by the video coder 330 (shown in FIG. 3) but may include some error. For pixel blocks coded predictively, the transform decoding may generate residual data; the decoder 222 may use motion vectors associated with the pixel blocks to retrieve predicted pixel blocks from the reference picture cache 224 to be combined with the prediction residuals. The prediction mode selector 226 may identify a temporal prediction mode being used for each pixelblock of an encoded frame being decoded and request the needed data for the decoding to be read from the reference picture cache 224.

The video decoder 220 may perform decoding operations according to a predetermined protocol, such as H.263, H.264, MPEG-2, HEVC. In its operation, the video decoder 220 may perform various decoding operations, including predictive decoding operations that exploit temporal and spatial redundancies in the encoded video sequence. The coded video data, therefore, may conform to a syntax specified by the protocol being used.

The parameters may be received as part of the syntax specified by the protocol in the coded video data, or appended as ancillary portion of the coded video data, to allow for backward compatibility.

In an embodiment, the receiver 210 may receive additional data with the encoded video. The additional data may be included as part of the encoded video frames. The additional data may be used by the video decoder 220 to properly decode the data and/or to more accurately reconstruct the original video data.

FIG. 3 may be a functional block diagram of a video coding system 300 according to an embodiment of the present invention.

The system 300 may include a video source 310 that provides video data to be coded by the system 300, a video coder 330, a transmitter 340, and a controller 350 to manage operation of the system 300. The controller 350 may control the video coder 330 to code and compress the image information from the video source 310 into video data, based upon one or more parameters. The transmitter 340 may transmit the video data.

The video source 310 may provide video to be coded by the system 300. In a media serving system, the video source 310 may be a storage device storing previously prepared video. In a videoconferencing system, the video source 310 may be a camera that captures local image information as a video sequence. Video data typically may be provided as a plurality of individual frames that impart motion when viewed in sequence. The frames themselves typically may be organized as a spatial array of pixels.

According to an embodiment, the system 300 may code and compress the image information for frames of the video sequence in real time, based upon one or more parameters. The parameters may be determined by the controller 350 based upon measurement data from a plurality of sensors 370 and/or from the raw image information from the video source 310. The controller 350 may control the compression and coding in video coder 330, based on the parameters.

As part of its operation, the video coder 330 may perform motion compensated predictive coding, which codes an input frame predictively with reference to one or more previously-coded frames from the video sequence that were designated as “reference frames.” In this manner, the coding engine 332 codes differences between pixel blocks of an input frame and pixel blocks of reference frame(s) that may be selected as prediction reference(s) to the input frame.

The local decoder 333 may decode coded video data of frames that may be designated as reference frames. Operations of the coding engine 332 typically may be lossy processes. When the coded video data may be decoded at a video decoder (not shown in FIG. 3), the recovered video sequence typically may be a replica of the source video sequence with some errors. The local decoder 333 replicates decoding processes that will be performed by the video decoder on reference frames and may cause reconstructed reference frames to be stored in the reference picture cache 334. In this manner, the system 300 may store copies of reconstructed reference frames locally that have common content as the reconstructed reference frames that will be obtained by a far-end video decoder (absent transmission errors).

The predictor 335 may perform prediction searches for the coding engine 332. That is, for a new frame to be coded, the predictor 335 may search the reference picture cache 334 for image data (as candidate reference pixel blocks) that may serve as an appropriate prediction reference for the new frames. The predictor 335 may operate on a pixel block-by-pixel block basis to find appropriate prediction references. In some cases, as determined by search results obtained by the predictor 335, an input frame may have prediction references drawn from multiple frames stored in the reference picture cache 334.

The controller 350 may manage coding operations of the video coder 330, including, for example, selection of coding parameters to optimize motion prediction, which the predictor 335 may use to select through the candidate reference pixel blocks.

The transmitter 340 may buffer coded video data to prepare it for transmission via a communication channel 360, which may be a hardware/software link to a storage device which would store the encoded video data. The transmitter 340 may merge coded video data from the video coder 330 with other data to be transmitted, for example, coded audio data and/or ancillary data streams (sources not shown).

The controller 350 may manage operation of the system 300. During coding, the controller 350 may assign to each frame a certain frame type (either of its own accord or in cooperation with the controller 350), which may affect the coding techniques that may be applied to the respective frame. For example, frames often may be assigned as one of the following frame types:

An Intra Frame (I frame) may be one that may be coded and decoded without using any other frame in the sequence as a source of prediction.

A Predictive Frame (P frame) may be one that may be coded and decoded using earlier frames in the sequence as a source of prediction.

A Bi-directionally Predictive Frame (B frame) may be one that may be coded and decoded using both earlier and future frames in the sequence as sources of prediction.

Frames commonly may be parsed spatially into a plurality of pixel blocks (for example, blocks of 4×4, 8×8 or 16×16 pixels each) and coded on a pixel block-by-pixel block basis. Pixel blocks may be coded predictively with reference to other coded pixel blocks as determined by the coding assignment applied to the pixel blocks' respective frames. For example, pixel blocks of I frames may be coded non-predictively or they may be coded predictively with reference to pixel blocks of the same frame (spatial prediction). Pixel blocks of P frames may be coded non-predictively, via spatial prediction or via temporal prediction with reference to one previously coded reference frame. Pixel blocks of B frames may be coded non-predictively, via spatial prediction or via temporal prediction with reference to one or two previously coded reference frames.

The video coder 330 may perform coding operations according to a predetermined protocol, such as H.263, H.264, MPEG-2, HEVC. In its operation, the video coder 330 may perform various compression operations, including predictive coding operations that exploit temporal and spatial redundancies in the input video sequence. The coded video data, therefore, may conform to a syntax specified by the protocol being used.

In an embodiment, the transmitter 340 may transmit additional data with the encoded video. The video coder 330 may include such data as part of the encoded video frames.

In an embodiment, device sensor information from sensors 370 may be used to improve coding/compression efficiency, by compensating for orientation/location and movement. For example, gyroscopic sensors or accelerometers may measure how camera is oriented/located and moving (motion direction and amount), from frame to frame. The frame-to-frame sensor information about the camera may be used to give priorities to motion search candidates of possible reference pixel blocks, which would improve the speed and accuracy of selection of reference pixel blocks.

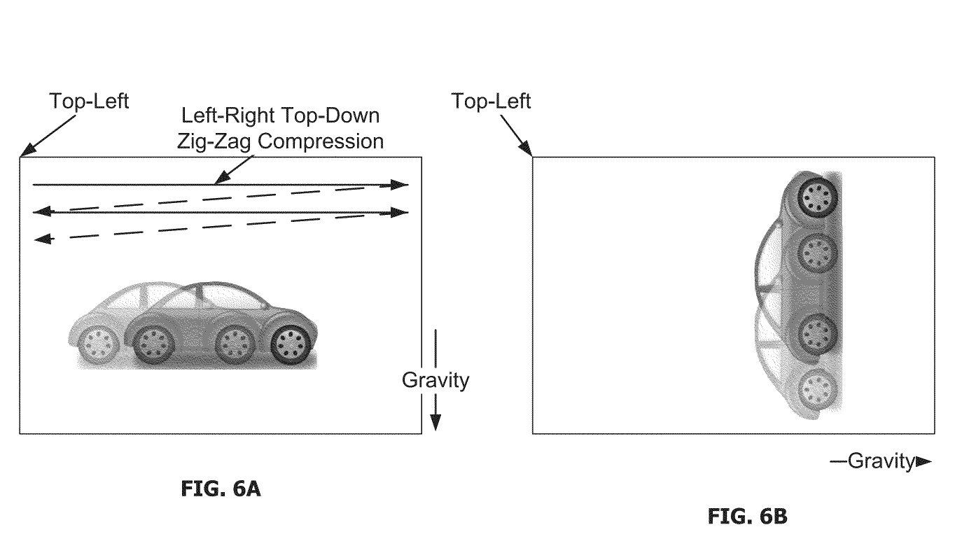

As stated above, the scanning order of the frame pixels during the compression may be a zig-zag pattern scanning from left to right and from top to bottom, (as shown in FIG. 6A's image frame of a moving car in a landscape view), having similar pixel blocks in the same zig-zag order can improve coding/compression efficiency.

In FIG. 6A, the car is moving from left to right relative to the top-left corner in the landscape view of a camera. Thus, the pixels for the car in a current frame would correlate most with pixels slightly on the left (relative to the pixels for the car in the current frame) in the previous frame in the video sequence. The video would be most efficiently encoded, if the reference pixel blocks for the car were selected from the pixel blocks on the left in the previous frame. If strong pixel correlation exists across several pixel blocks horizontal from each other, it would be more efficient that the selection of reference pixel blocks were chosen from the horizontally nearby pixel blocks (left or right).

However, in FIG. 6B, the view changed to a portrait view, and the car is moving from left to right, but relative to the previous landscape view of the camera, the car is moving from the bottom of the landscape view screen to the top of the landscape view screen. Now, the motion of the car in the video is more predictable in the vertical direction. Thus, the pixels for the car in a current frame would correlate most with pixels slightly toward the top side of the frame (relative to the pixels for the car in the current frame) in the previous frame in the video sequence. The video would be most efficiently encoded, if the reference pixel blocks for the car were selected from the pixel blocks toward the top side in the previous frame. If strong pixel correlation exists across several pixel blocks vertically from each other, it would be more efficient that the selection of reference pixel blocks were chosen from the vertically nearby pixel blocks (above or below).

Thus, if camera device conditions can be measured, the orientation and motion of the camera device may be taken into consideration to improve the encoding the video data. Camera/frame rotation may be used to determine motion prediction parameters, which may be signaled to decoder. For example, in HEVC standard, Sequence Parameter Set (SPS) syntax pic_width_in_luma_samples/pic_height_in_luma_samples may be used for multiple SPS's and associated SPS id may be used to properly switch between landscape and portrait, in a continuous stream of video data.

In an embodiment, orientation information can be derived, without signaling directly in the syntax, at the decoder using previous frame information, e.g., by assuming that majority of motions would be aligned to the selected direction for motion prediction encoding/compression, determining whether majority of motions from a previous frame to a current frame is horizontal or vertical in landscape view, and then orient decoding accordingly.

If the camera device itself is moving (or rotating), the motion/rotational direction and amount measured at the camera device by sensors 370 may be also used for motion prediction. Instead of searching for example N×N (horizontal, vertical) # of different pixel blocks near the pixel block of interest, the controller 350 may adjust search range in the predictor 335 adaptively to for example, 2N×(N/2), 4N×(N/4), etc., to lengthen the search range horizontally and shorten the search range vertically, depending on the magnitude of the detected camera motion by sensor. The search range of the different pixel blocks may also be skewed toward a specific direction. For example, assuming that 4N×(N/4) blocks of pixel blocks is selected as the search range size, if the camera device is moving/rotating toward the left, then objects in the video would appear to move from the left to the right, and more predictive pixel blocks would be more toward the left in the previous frames, so the 4N×(N/4) blocks may be more skewed toward the left, for example, 3N blocks size on the left and 1N blocks size on the right of the current pixel block of interest.

Also if the camera motion is fast between frames, more motion blurs may be expected, and larger size individual pixel block may be used for coding efficiency. With other side information from the sensors 370, such as GPS data, other motion prediction related features may be implemented. For example, object locations between frames may be extrapolated, and/or the object images in the reference frames may be warped/transformed/transposed to improve prediction quality and image quality, such as to sharpen the image of moving objects or to decrease blurring.

From the motion detected using device sensor information, motion vector predictors (mvp) and merge candidates (used for selecting reference pixel blocks) can be added and/or reordered. Typically, mvp's and merge candidates are ordered along horizontal neighbors of pixel blocks then vertical neighbors as listed below;
The merging candidate list, mergeCandList, is constructed as follows:

```
i = 0
if( availableFlagA₁ )
  mergeCandList[ i++ ] = A₁
if( availableFlagB₁ )
  mergeCandList[ i++ ] = B₁
if( availableFlagB₀ )
  mergeCandList[ i++ ] = B₀
if( availableFlagA₀ )
  mergeCandList[ i++ ] = A₀
if( availableFlagB₂ )
  mergeCandList[ i++ ] = B₂
if( availableFlagCol )
  mergeCandList[ i++ ] = Col
```

So the order of merge candidates is then A1→B1→B0→A0→B2. A0 represents the pixel block directly to the left and below. A1 represents the pixel block directly to the left. B0 represents the pixel block directly to the right and above. B1 represents the pixel block directly above. B2 represents the pixel block directly to the left and above. Here, A1 the pixel block directly to the left is prioritized in the merge candidate list.

If the motions in the frame are vertical rather than horizontal, we may reorder this as B1→A1→A0→B0→B2 or B1→A1→B0→A0→B2, etc. Here, B1 the pixel block directly above is prioritized in the merge candidate list. Therefore, merge candidate order can be modified for example using a conditional list as listed below;
The merging candidate list, mergeCandList, is constructed as follows

```
i = 0
if (reorder_mvp_merge_cand==0) {
if( availableFlagA₁ )
  mergeCandList[ i++ ] = A₁
if( availableFlagB₁ )
  mergeCandList[ i++ ] = B₁
if( availableFlagB₀ )
  mergeCandList[ i++ ] = B₀
if( availableFlagA₀ )
  mergeCandList[ i++ ] = A₀
if( availableFlagB₂ )
  mergeCandList[ i++ ] = B₂
if( availableFlagCol )
  mergeCandList[ i++ ] = Col
  } else {
if( availableFlagA₁ )
  mergeCandList[ i++ ] = B₁
if( availableFlagB₁ )
  mergeCandList[ i++ ] = A₁
if( availableFlagB₀ )
  mergeCandList[ i++ ] = A₀
if( availableFlagA₀ )
  mergeCandList[ i++ ] = B₀
if( availableFlagB₂ )
  mergeCandList[ i++ ] = B₂
if( availableFlagCol )
  mergeCandList[ i++ ] = Col
  }
```

In the listed order above, the new syntax reorder_mvp_merge_cand may be used to signal whether reordering is needed. The listed order above may have additional order lists possible in the conditional list, and the new syntax reorder_mvp_merge_cand may include additional device orientation information to allow more complex merge candidate order lists. This additional syntax may be added to the syntax of slice_segment_header( ) in HEVC protocol for example.

Additionally, other merge candidates may be added to the list above, to provide additional and possibly better correlated merge candidates for video coding. Additional merge candidates may be selected as needed according to various video encoding/decoding standards, if available.

In an embodiment, the other aspects of encoded video data may be affected according to the orientation parameters to improve efficiencies. For example, as the video camera is rotated, video coding structures and information, such as syntax priorities, search priorities, entropy coding syntax/contents order, etc., may be coded to align with the new horizontal direction during/after the rotation. This may provide additional efficiencies because of correlations in the horizontal direction, above and beyond motion prediction.

In an embodiment, as the front camera in a mobile device tends to be closer to the objects than the back camera, the motion between frames captured by the front camera may be expected to be larger than the motion captured by the back camera. Thus, the search range for the frames captured by the front camera may need to be increased relative to the back camera.

In an embodiment, face detection information may be used as part of motion prediction parameter. If faces are detected in the captured video frame, the coordinates for the faces detected in different frames may be used to more selectively prioritize those faces as the region of interest (ROI) and select the search region for coding.

In an embodiment, when frame is rotated, multiple SPS can be defined with different pic_width_in_luma_samples/pic_height_in_luma_samples and associated SPS id can be signaled in the encoded video data, to allow a video decoder to know the orientation of the frame used for encoding and decoding and motion prediction.

In an embodiment, a new syntax may be included, for example, by adding to SPS, PPS, slice headers. Because of the dependency of other syntaxes on pic_width and pic_height, all syntaxes and parameters depending on pic_width and pic_height may also need to be modified accordingly. For example, swap_width_height may be included in slice_segment_header( ) as shown below;

| slice_segment_header( ) { | Descriptor |
|---|---|
| first_slice_segment_in_pic_flag | u(1) |
| if( nal_unit_type >= BLA_W_LP && nal_unit_type <= | |
| RSV_IRAP_VCL23 ) | |
| no_output_of_prior_pics_flag | u(1) |
| slice_pic_parameter_set_id | ue(v) |
| if( !first_slice_segment_in_pic_flag ) { | |
| if( dependent_slice_segments_enabled_flag ) | |
| dependent_slice_segment_flag | u(1) |
| slice_segment_address | u(v) |
| } else { | |
| swap_width_height | u(1) |
| } | |
| if( !dependent_slice_segment_flag ) { | |
| ... | |
| } | |
| byte_alignment( ) | |
| } | |

If the motions in a slice are vertical rather than horizontal, mvp's and merge candidates may be reordered as previously explained. Associated syntax, reorder_mvp_merge_cand may be added into slice_segment_header( ) as shown below.

| slice_segment_header( ) { | Descriptor |
|---|---|
| first_slice_segment_in_pic_flag | u(1) |
| ... | |
| if( !dependent_slice_segment_flag ) { | |
| ... | |
| if( slice_type == P \|\| slice_type == B ) { | |
| num_ref_idx_active_override_flag | u(1) |
| if( num_ref_idx_active_override_flag ) { | |
| num_ref_idx_l0_active_minus1 | ue(v) |
| if( slice_type == B ) | |
| num_ref_idx_l1_active_minus1 | ue(v) |
| } | |
| if( lists_modification_present_flag && | |
| NumPocTotalCurr > 1 ) | |
| ref_pic_lists_modification( ) | |
| if( slice_type == B ) | |
| mvd_l1_zero_flag | u(1) |
| if( cabac_init_present_flag ) | |
| cabac_init_flag | u(1) |
| if( slice_temporal_mvp_enabled_flag ) { | |
| if( slice_type == B ) | |
| collocated_from_l0_flag | u(1) |
| if( ( collocated_from_l0_flag && | |
| num_ref_idx_l0_active_minus1 > 0 ) \|\| | |
| ( !collocated_from_l0_flag | |
| && num_ref_idx_l1_active_minus1 > 0 ) ) | |
| collocated_ref_idx | ue(v) |
| } | |
| reorder_mvp_merge_cand | u(1) |
| if( ( weighted_pred_flag && slice_type == P ) \|\| | |
| weighted_bipred_flag && slice_type == B) ) | |
| pred_weight_table( ) | |
| five_minus_max_num_merge_cand | ue(v) |
| } | |
| ... | |
| } | |
| ... | |
| } | |

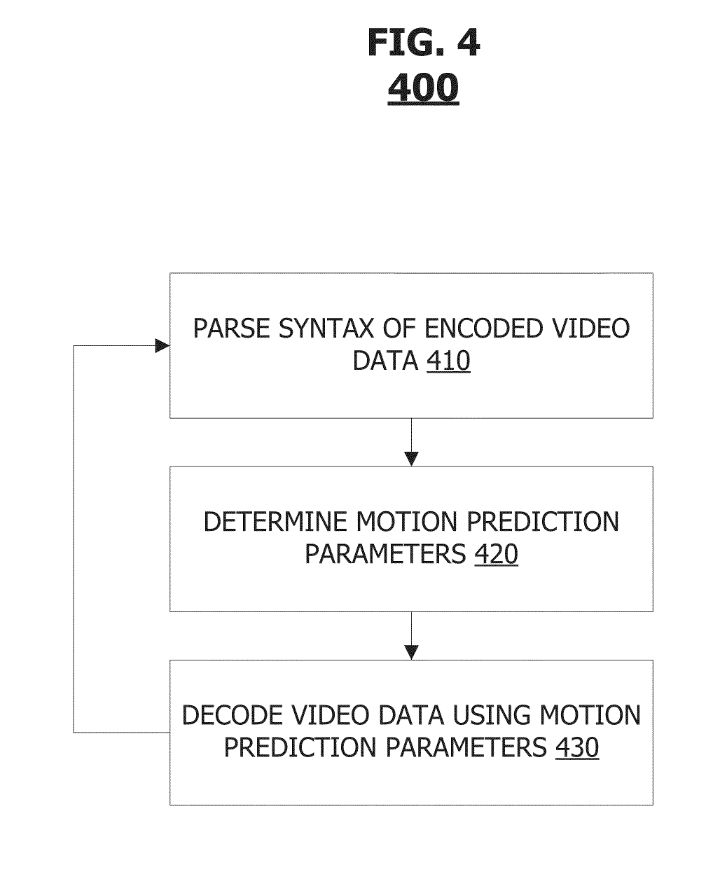

FIG. 4 illustrates a decoding method 400 according to an embodiment of the present disclosure.

At block 410, the system 200 may parse the syntax of the encoded video data.

At block 420, the controller 228 may determine, from the parsed syntax, motion prediction parameters.

At block 430, the controller 228 may control the video decoder 220 to decode video data using the motion prediction parameters.

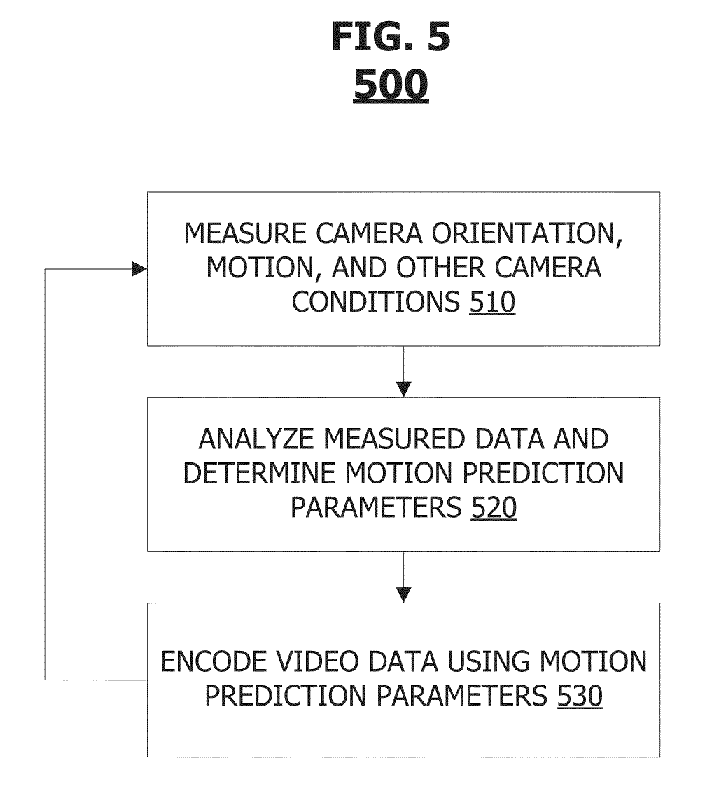

FIG. 5 illustrates a coding method 500 according to an embodiment of the present disclosure.

At block 510, the system 300 may measure various condition data for the camera system 300, such as camera orientation, camera motion (amount and direction), and other data, using sensors 370 or the video source 310.

At block 520, the controller 350 may analyze the measured data and determine motion prediction parameters.

At block 530, the video coder 330 may encode video data using the motion prediction parameters.

It is appreciated that the disclosure is not limited to the described embodiments, and that any number of scenarios and embodiments in which conflicting appointments exist may be resolved.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed:

1. A system comprising:
a receiver receiving encoded video data;
a decoder decoding the encoded video data; and
a controller adjusting motion prediction in the decoder, based upon at least one parameters corresponding to conditions of an imaging device that captured video data.

2. The system of claim 1, wherein the controller adjusts motion prediction based upon a plurality of reference pixel blocks selected based upon orientation of the imaging device.

3. The system of claim 1, wherein the controller adjusts motion prediction based upon a plurality of reference pixel blocks selected based upon direction and magnitude of motion of the imaging device.

4. A system comprising:
a imaging sensor capturing video image;
a plurality of sensors measuring conditions of the system;
an encoder encoding the video image into encoded video data; and
a controller adjusting motion prediction in the encoder, based upon at least one parameters corresponding to the conditions of the system.

5. The system of claim 4, wherein the plurality of sensors comprise at least one of a gyroscopic sensor, an accelerometer, and a GPS sensor.

6. The system of claim 4, wherein the controller adjusts motion prediction by adjusting the number of reference pixel blocks in the horizontal direction or in the vertical direction as candidates for motion prediction.

7. The system of claim 4, wherein the controller adjusts motion prediction by changing the order of search priorities of reference pixel blocks as candidates for motion prediction.

8. The system of claim 4, wherein the controller adjusts motion prediction based upon a plurality of reference pixel blocks selected based upon orientation of the imaging device.

9. The system of claim 4, wherein the controller adjusts motion prediction based upon a plurality of reference pixel blocks selected based upon direction and magnitude of motion of the imaging device.

10. The system of claim 4, wherein the encoder encodes the at least one parameters into the syntax of the encoded video data.

11. A method comprising:
receiving, by a receiver, encoded video data;
decoding, by a decoder, the encoded video data; and
adjusting, by a controller, motion prediction in the decoder, based upon at least one parameters corresponding to conditions of an imaging device that captured video data.

12. The method of claim 11, wherein the controller adjusts motion prediction based upon a plurality of reference pixel blocks selected based upon orientation of the imaging device.

13. The method of claim 11, wherein the controller adjusts motion prediction based upon a plurality of reference pixel blocks selected based upon direction and magnitude of motion of the imaging device.

14. A system comprising:
capturing, by a imaging sensor, video image;
measuring, by a plurality of sensors, conditions of the system;
encoding, by an encoder, the video image into encoded video data; and
adjusting, by a controller, motion prediction in the encoder, based upon at least one parameters corresponding to the conditions of the system.

15. The method of claim 14, wherein the plurality of sensors comprise at least one of a gyroscopic sensor, an accelerometer, and a GPS sensor.

16. The method of claim 14, wherein the controller adjusts motion prediction by adjusting the number of reference pixel blocks in the horizontal direction or in the vertical direction as candidates for motion prediction.

17. The method of claim 14, wherein the controller adjusts motion prediction by changing the order of search priorities of reference pixel blocks as candidates for motion prediction.

18. The method of claim 14, wherein the controller adjusts motion prediction based upon a plurality of reference pixel blocks selected based upon orientation of the imaging device.

19. The method of claim 14, wherein the controller adjusts motion prediction based upon a plurality of reference pixel blocks selected based upon direction and magnitude of motion of the imaging device.

20. The method of claim 14, wherein the encoder encodes the at least one parameters into the syntax of the encoded video data.

21. A system comprising:
a imaging sensor capturing video image;
a plurality of sensors measuring conditions of the system;
an encoder encoding the video image into encoded video data; and
a controller adjusting at least one order of priorities and sequences of video data in the encoder, based upon at least one parameters corresponding to the conditions of the system.

22. The system of claim 21, wherein the controller adjusts at least one of syntax priorities, search priorities, entropy coding syntax, and entropy coding order.
